(19) United States
(12) Patent Application Publication
(10) Pub. No.: US 2015/0103173 A1
(43) Pub. Date: Apr. 16, 2015

(54) SYNTHESIZED IMAGE GENERATION DEVICE

(71) Applicant: DENSO CORPORATION, Kariya-city (JP)

(72) Inventor: Masanari TAKAKI, Chiryu-shi (JP)

(21) Appl. No.: 14/499,485

(22) Filed: Sep. 29, 2014

(30) Foreign Application Priority Data
Oct. 16, 2013 (JP) 2013-215649

(51) Int. Cl. B60R 11/04; G06K 9/00

(52) U.S. Cl. CPC B60R 11/04; G06K 9/00798; B60R 2300/105; B60R 2300/303
USPC 348/148

(57) ABSTRACT

In a synthesized image generation device, an image processing section receives acquired images transmitted from in-vehicle cameras, and selects some of the acquired images having different image acquiring regions which are not overlapped with each other. The image processing section generates synthesized image data on the basis of the selected acquired images. This avoids a process of cutting a predetermined image area from the acquired images during the generation of the synthesized image data as a bird's eye view. It is possible for the image processing section to prevent a part of a clear acquired image from being cut and eliminated even if the clear acquired image and unclear acquired image are selected simultaneously and combined, and extract road markings from the synthesized image data with high accuracy.

### CROSS-REFERENCE TO RELATED APPLICATION

This application is related to and claims priority from Japanese Patent Application No. 2013-215649 filed on Oct. 16, 2013, the contents of which are hereby incorporated by reference.

### BACKGROUND OF THE INVENTION

1. Field of the Invention

The present invention relates to synthesized image generation devices capable of combining a plurality of acquired images transmitted from in-vehicle cameras and generating synthesized image data as bird's eye images.

2. Description of the Related Art

There has been known a conventional synthesized image generation device which receives acquired images transmitted from a plurality of in-vehicle cameras mounted on a motor vehicle. The in-vehicle cameras are arranged around the motor vehicle and acquire images. The conventional synthesized image generation device generates a bird's-eye view on the basis of the acquired images. The bird's-eye view is a top view of the motor vehicle when observed from above the motor vehicle. When a part of each of the acquired images transmitted from the in-vehicle cameras is overlapped with each other, the conventional synthesized image generation device cuts an overlapped part between the acquired images, and synthesizes the remained acquired images in order to make synthesized image data which show bird's-eye views of the motor vehicle.

The driver of the motor vehicle uses the generated bird's-eye view, i.e. the synthesized image data of the motor vehicle in order to recognize an environment state around the motor vehicle. In addition, it is possible to use the generated bird's-eye view, i.e. the synthesized image data of the motor vehicle in order to extract road markings, for example a lane line on a road from the synthesized image data, where these road markings are on roads by using a road making paint. That is, lane lines as road markings are on roads and highways by using a road making paint. However, when the acquired images transmitted from the in-vehicle cameras contain strong light such as strong sunlight and/or strong beams irradiated from an illuminated advertising pillar, the acquired images contain black defects in which an area other than a strong light in the acquired image has black. As a result, the synthesized image data have a decreased effective small area from which road markings such as lane lines are correctly extracted.

Further, the same phenomenon occurs when water drops or stains which adhere on the surfaces of lenses of the in-vehicle cameras. These cases have a possible difficulty of correctly extracting lane lines and other road markings on the surface of the road around the motor vehicle from the synthesized image data.

### SUMMARY

It is therefore desired to provide a synthesized image generation device, to be mounted on a motor vehicle, capable of synthesizing acquired images transmitted from a plurality of acquiring sections such as a plurality of in-vehicle cameras arranged around the own vehicle, and generating synthesized image data from which road markings such as lane lines on the surface of the road are correctly extracted.

An exemplary embodiment provides a synthesized image generation device which is mounted on a motor vehicle. The synthesized image generation device has an image acquiring section, an acquired image selection section, and a synthesized image generation section. The image acquiring section obtains acquired images transmitted from a plurality of in-vehicle cameras. The acquired image selection section selects the acquired images transmitted from the in-vehicle cameras so that image acquiring regions of the in-vehicle cameras are not overlapped with each other. The selected acquired images are used for extracting road markings on a surface of a road. The synthesized image generation section combines the selected acquired images and generates synthesized image data.

The synthesized image generation device having the structure previously described generates synthesized image data as a combination if acquired images transmitted from the selected in-vehicle cameras whose image acquiring regions are not overlapped with each other. This avoids a process of cutting a predetermined image area from the acquired images during the process of generating the synthesized image data. That is, this prevents a part of a clear acquired image from being cut and eliminated even if the clear acquired image and unclear acquired image are selected simultaneously and combined. It is possible for the synthesized image generation device to easily detect road markings on the surface of a road and extract the road markings from the synthesized image data with high accuracy.

It is possible to use software equivalent to the functions of the synthesized image generation device having the structure previously described.

### BRIEF DESCRIPTION OF THE DRAWINGS

A preferred, non-limiting embodiment of the present invention will be described by way of example with reference to the accompanying drawings, in which:

FIG. 1 is a block diagram showing a schematic structure of an image display system 1 equipped with an image processing section 10 as a synthesized image generation device according to an exemplary embodiment of the present invention;

FIG. 2 is a bird's-eye view showing a schematic arrangement of in-vehicle cameras 21 to 24 in the image display system 1 mounted on an own vehicle equipped with the synthesized image generation device according to the exemplary embodiment of the present invention;

FIG. 3 is a flow chart showing a lane line recognition process performed by a central processing unit 11 in the image processing section 10 as the synthesized image generation device according to the exemplary embodiment of the present invention;

FIG. 4A and FIG. 4B are bird's eye views showing a combination of images acquired by in-vehicle cameras 21 to 24 in the image display system 1 which will be processed by the image processing section 10 as the synthesized image generation device according to the exemplary embodiment of the present invention;

FIG. 5A to FIG. 5C are views showing a driving scene in a rainy day as one example of synthesized image data generated by the image processing section 10 as the synthesized image generation device according to the exemplary embodiment of the present invention;

FIG. 6A to FIG. 6C are views showing a driving scene in a sunny day as one example of synthesized image data generated by the image processing section 10 as the synthesized image generation device according to the exemplary embodiment of the present invention;

FIG. 7A and FIG. 7B are views showing one example of synthesized image data transmitted from a conventional synthesized image generation device;

FIG. 8A and FIG. 8B are bird's eye views of a first example showing a combination of images acquired by the in-vehicle cameras to be processed by the image processing section 10 as the synthesized image generation device according to a first modification of the exemplary embodiment of the present invention; and

FIG. 9A to FIG. 9C are bird's eye views of a second example showing a combination of images acquired by the in-vehicle cameras to be processed by the image processing section 10 as the synthesized image generation device according to a second modification of the exemplary embodiment of the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### Exemplary Embodiment

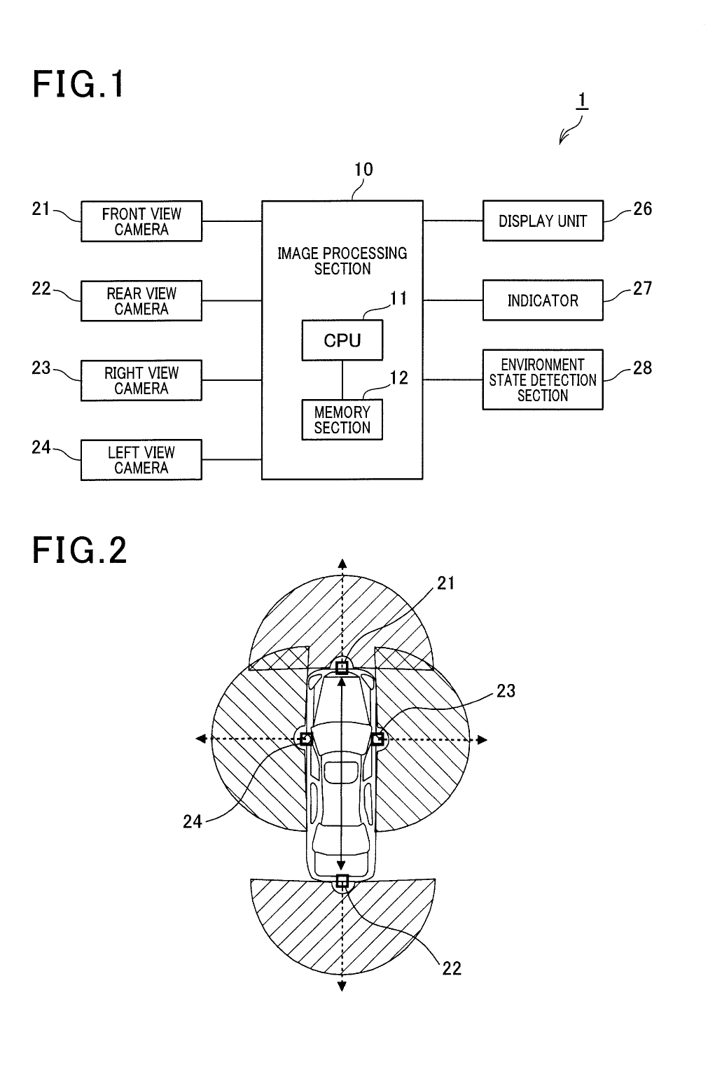

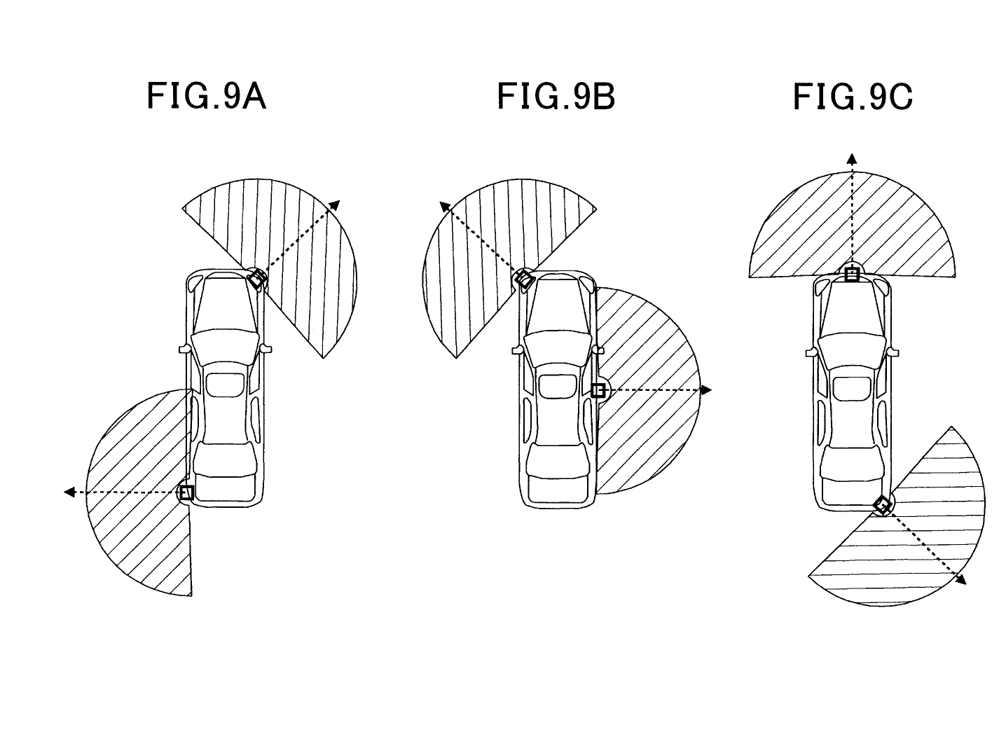

A description will be given of a synthesized image generation device according to an exemplary embodiment with reference to FIG. 1 to FIG. 9A, FIG. 9B and FIG. 9C. For example, an image display system 1 is mounted on a motor vehicle (hereinafter, referred to as the “own vehicle”). The image display system 1 is equipped with the synthesized image generation device according to the exemplary embodiment.

An image processing section 10 having a central processing unit (CPU) 11 shown in FIG. 1 is equivalent to the synthesized image generation device according to the exemplary embodiment. The image processing section 10 receives acquired images transmitted from in-vehicle cameras 21 to 24. The image processing section 10 generates synthesized image data on the basis of the acquired images, and recognizes road markings such as lane lines, etc. from the generated synthesized image data. These road markings are on the surfaces of roads by using a road making paint.

FIG. 1 is a block diagram showing a schematic structure of the image display system 1 equipped with the image processing section 10 as the synthesized image generation device according to an exemplary embodiment. As shown in FIG. 1, the image display system 1 has the image processing section 10, a plurality of the in-vehicle cameras 21 to 24, a display unit 26, an indicator 27, and an environment state detection section 28.

The in-vehicle cameras 21 to 24 are a combination of the front view camera 21, the rear view camera 22, the right view camera 23 and the left view camera 24. Those in-vehicle cameras 21 to 24 have image acquiring regions, respectively, designated by hatched areas shown in FIG. 2. Each of the in-vehicle cameras 21 to 24 acquires road markings such as lane lines on the surface of the road within its image acquiring region.

FIG. 2 is a bird's-eye view showing a schematic arrangement of the in-vehicle cameras 21 to 24 in the image display system 1 mounted on the own vehicle equipped with the synthesized image generation device according to the exemplary embodiment. That is, FIG. 2 shows each of the image acquiring regions having a fan shape or a half circular shape. However, an actual image acquiring area of each of the in-vehicle cameras 21 to 24 has an optional shape which is slightly different from such fan shape.

In more detail, the front view camera 21 is arranged inside of a front bumper of the own vehicle and acquires an image of the road in front of the own vehicle (hereinafter, referred to as the “front view image”).

The rear view camera 22 is arranged inside of a rear bumper of the own vehicle and acquires an image of the road at a rear side of the own vehicle (hereinafter, referred to as the “rear view image”).

The right view camera 23 is arranged at the right wing mirror of the own vehicle and acquires an image of the road at a right side of the own vehicle (hereinafter, referred to as the “right side view image”).

The left view camera 24 is arranged at the left wing mirror of the own vehicle and acquires an image of the road at a left side of the own vehicle (hereinafter, referred to as the “left side view image”).

Each of the in-vehicle cameras 21 to 24, i.e. the front view camera 21, the rear view camera 22, the right view camera 23 and the left view camera 24 acquires the image every 33 ms interval and transmits the acquired image to the image processing section 10, for example.

The display unit 26 receives display instruction signals transmitted from the image processing section 10 and displays an image on the basis of the received display instruction signals. The indicator 27 also receives the display instruction signals transmitted from the image processing section 10 and provides visual information to the driver of the own vehicle on the basis of the received display instruction signals. For example, the visual information in the display instruction signals transmitted from the image processing section 10 indicates a degree in recognition accuracy of the detected road markings such as lane line on the road on which the own vehicle drives. For example, the indicator 27 is equipped with a plurality of emitting sections, and adjusts the number of the emitting sections on the basis of the display instruction signals transmitted from the image processing section 10.

The recognition accuracy of a road marking, for example, the detected lane line on the surface of the road by using a road making paint indicates an accuracy of a lane line extraction process (step S135 which will be explained later in detail). The image processing section 10 generates and outputs the display instruction signals corresponding to this recognition accuracy to the indicator 27

The environment state detection section 28 detects a current state of the image acquiring conditions of the in-vehicle cameras 21 to 24. For example, the environment state detection section 28 detects a direction of a light source such as sun light, the presence of stains which adhere on lenses of the in-vehicle cameras 21 to 24, the presence of water drop or fog. The modifications of the exemplary embodiment will disclose the feature and operation of the environment state detection section 28.

Because a microcomputer is easily available on the commercial market, it is possible to use a microcomputer as the image processing section 10. In general, the available microcomputer has a central processing unit (CPU) 11, a read only memory (ROM) and a random access memory (RAM), etc. The memory section such as the ROM and the RAM stores programs which contain a synthesized image generation program. The CPU 11 performs various types of programs stored in the memory section such as a lane line recognition process which will be explained later in detail.

A description will now be given of the process of the synthesized image generation device according to the exemplary embodiment.

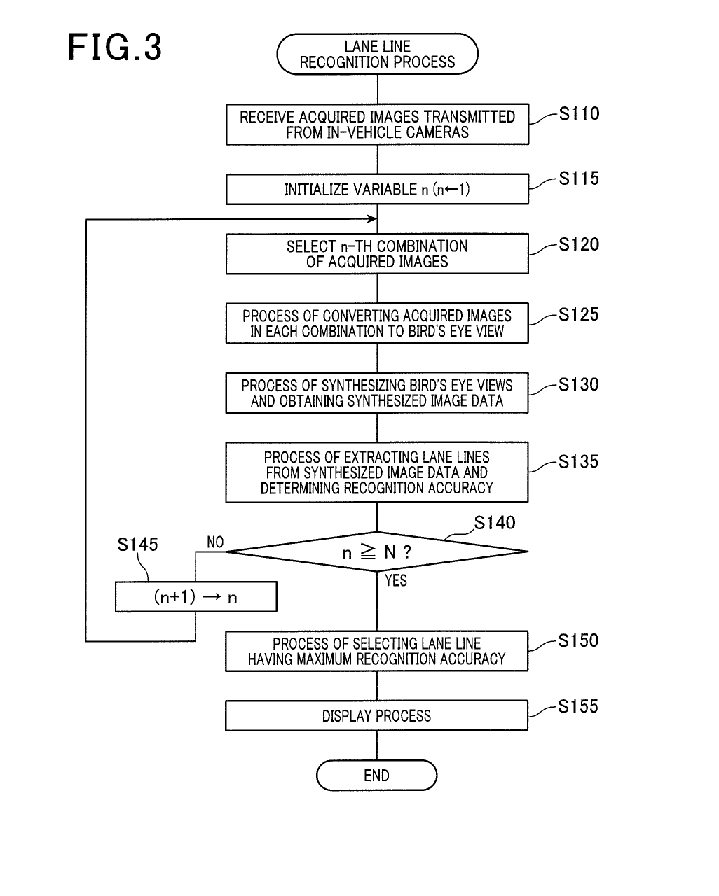

FIG. 3 is view showing a flow chart of a lane line recognition process performed by the CPU 11 in the image processing section 10 as the synthesized image generation device according to the exemplary embodiment.

In the image display system 1 having the structure previously described, the image processing section 10 performs the lane line recognition process indicated by the flow chart shown in FIG. 3. For example, when receiving electric power supplied from a power supply (not shown), the image processing section 10 initiates the execution of the lane line recognition process. The image processing section 10 repeatedly performs the lane line recognition process every predetermined interval (for example every 33 ms).

In the lane line recognition process shown in FIG. 3, the image processing section 10 receives acquired images transmitted from the in-vehicle cameras 21 to 24, i.e. the front view camera 21, the rear view camera 22, the right view camera 23 and the left view camera 24 (step S110). The operation flow goes to step S115. The image processing section 10 initializes a variable n (1→n) (step S115). The image processing section 10 selects a combination of the acquired images, i.e. the received images indicated by a n-th value which corresponds to the variable n (step S120).

The n-th value indicates the combination of the acquired images to be used for generating synthesized image data.

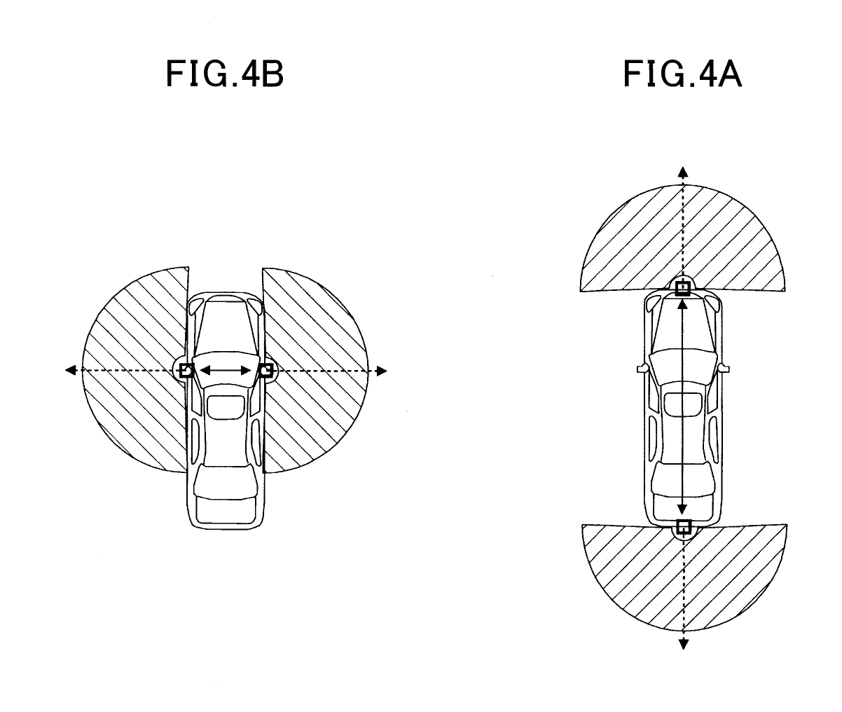

FIG. 4A and FIG. 4B are bird's eye views which show a combination of the acquired images acquired by the front view camera 21 and the acquired image transmitted from the rear view camera 22 which will be processed by the image processing section 10 as the synthesized image generation device according to the exemplary embodiment.

For example, the image processing section 10 according to the exemplary embodiment selects a combination of the acquired front view image transmitted from the front view camera 21 and the acquired rear view image transmitted from the rear view camera 22, as shown in FIG. 4A.

Further, the image processing section 10 selects a combination of the acquired right side view image transmitted from the right view camera 23 and the acquired left side view image transmitted from the left view camera 24, as shown in FIG. 4B.

The image processing section 10 selects a plurality of combinations, each combination includes acquired images which are opposite views when observed from the own vehicle so that the selected acquired images in each combination are not overlapped in image acquiring region to each other.

The operation flow goes to step S125. In step S125, the image processing section 10 performs a process for converting acquired images belonging to each combination to synthesized image data as a bird's eye view. The conversion process performs a coordination conversion of each pixel in the acquired images in the combination in order to make the bird's eye view on the basis of a geometric transformation table. This geometric transformation table is used for converting each image in the n-th combination to the bird's eye view observed from above the own vehicle.

The operation flow goes to step S130. In step S130, the image processing section 10 performs a process of synthesizing the bird's eye views corresponding to the acquired images selected in step S120. In this synthesizing process, the image processing section 10 generates a synthesized bird's eye view, i.e. the synthesized image data. In more detail, a plurality of the generated bird's eye views, i.e. the synthesized image data are arranged around the predetermined bird's eye view of the own vehicle which has been prepared.

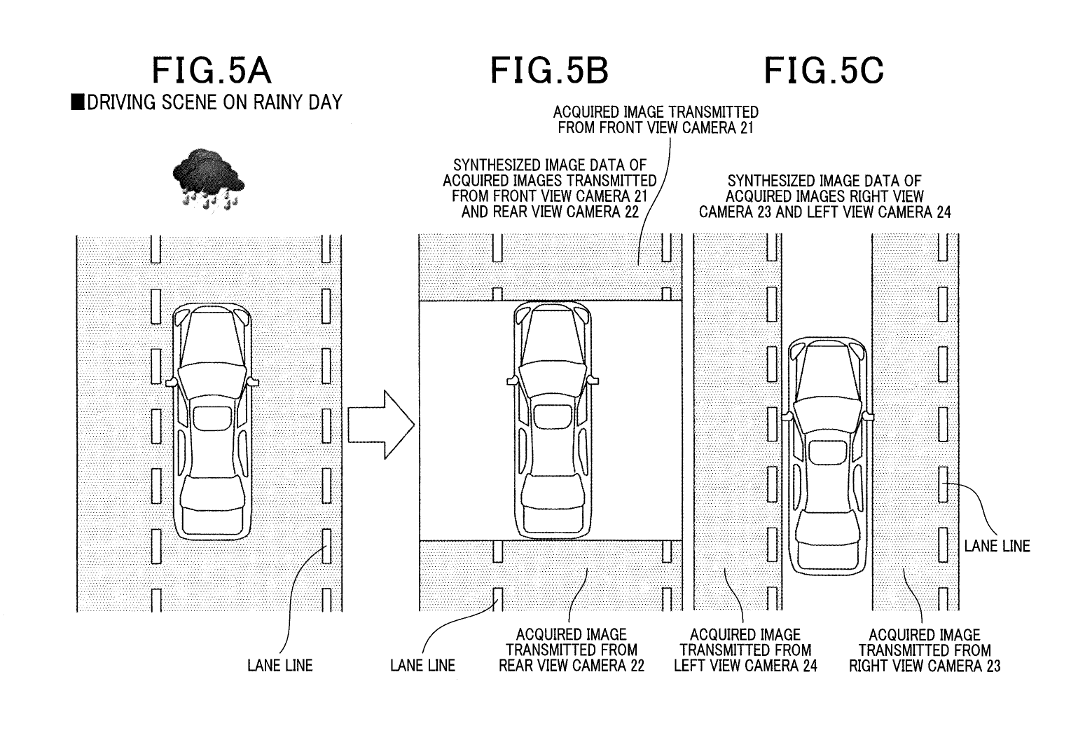

A description will now be given of a driving scene in which the own vehicle drives on a drive lane of a road on a rainy day with reference to FIG. 5A to FIG. 5C.

FIG. 5A to FIG. 5C are views showing a driving scene on a rainy day as one example of synthesized image data generated by the image processing section 10 as the synthesized image generation device according to the exemplary embodiment.

When the own vehicle is running on the road on a rainy day shown in FIG. 5A, the front view camera 21 and the rear view camera 22 acquire a front view image of the road and a rear view image of the road, respectively, shown in FIG. 5B. In addition, the front view camera 21 and the rear view camera 22 acquire a right side view image and a left side view image of the road, respectively, shown in FIG. 5C.

That is, the image processing section 10 according to the exemplary embodiment obtains visual image data with which the driver of the own vehicle can recognize a lane line on the surface of the road. However, if it is a rainy day, there is a possible case in which water drops are adhered on at least one of the surfaces of the lenses of the front view camera 21 and the rear view camera 22, and the captured image becomes unclear. It can be considered in view of a direction of wind in such a heavy rainy day that at least one of the front view camera 21 and the rear view camera 22 acquires a clear image.

In addition, it can be considered that at least one of the right view camera 23 and the left view camera 24 acquires a clear image, i.e. at least one of the left side view image acquired by the right view camera 23 and the left side view image acquired by the left view camera 24 has a clear image. Accordingly, it is possible for the image processing section 10 to extract both a lane line at the right side of the own vehicle and a lane line at the left side of the own vehicle when extracting the lane lines from the synthesized image data of these acquired images.

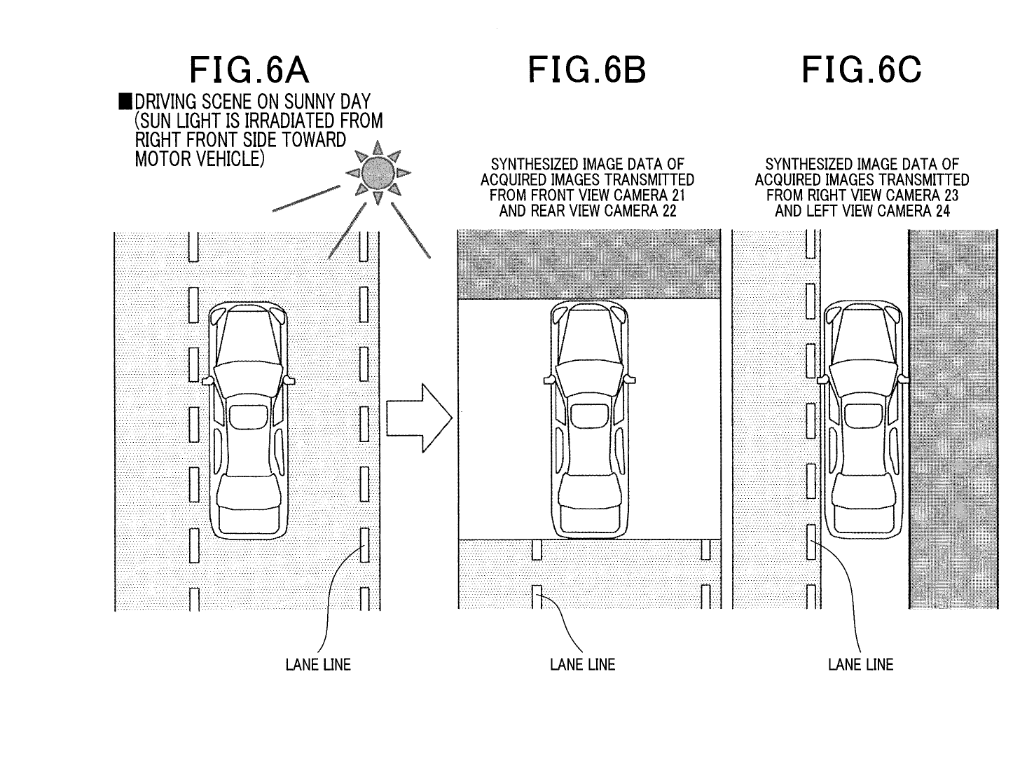

A description will now be given of a driving scene in which the own vehicle drives on a drive lane of the road in a sunny day with reference to FIG. 6A to FIG. 6C.

FIG. 6A to FIG. 6C are views showing a driving scene in a sunny day as one example of synthesized image data generated by the image processing section 10 as the synthesized image generation device according to the exemplary embodiment.

That is, FIG. 6A is a view showing a driving scene in a sunny day in which the own vehicle drives on a drive lane of the road and sunlight is irradiated from an upper right direction to the own vehicle. As shown in FIG. 6B, blacked-out shadows occur in the acquired image transmitted from the front view camera 21, and it is difficult for the image processing section 10 to correctly recognize any lane line in the acquired image transmitted from the front view camera 21. On the other hand, it is possible for the image processing section 10 to clearly recognize two lane lines on the surface of the road in the acquired image transmitted from the rear view camera 22.

As shown in FIG. 6C, because blacked-out shadows occur in the acquired image transmitted from the right view camera 23, it is difficult for the image processing section 10 to recognize any lane line. On the other hand, because no blocked up shadow occur in the acquired image transmitted from the left view camera 24, it is possible for the image processing section 10 to easily recognize the presence of the lane line on the surface of the road.

As previously described, even if it is a sunny day and a strong light source is present around the own vehicle and a strong sunlight is irradiated toward the own vehicle, it is possible for at least one of the in-vehicle cameras 21 to 24 to correctly acquire a correct image of a lane line on the surface of the road on which the own vehicle drives, and extract the lane lines present on the right side and the left side of the own vehicle from the synthesized image data obtained from the acquired images.

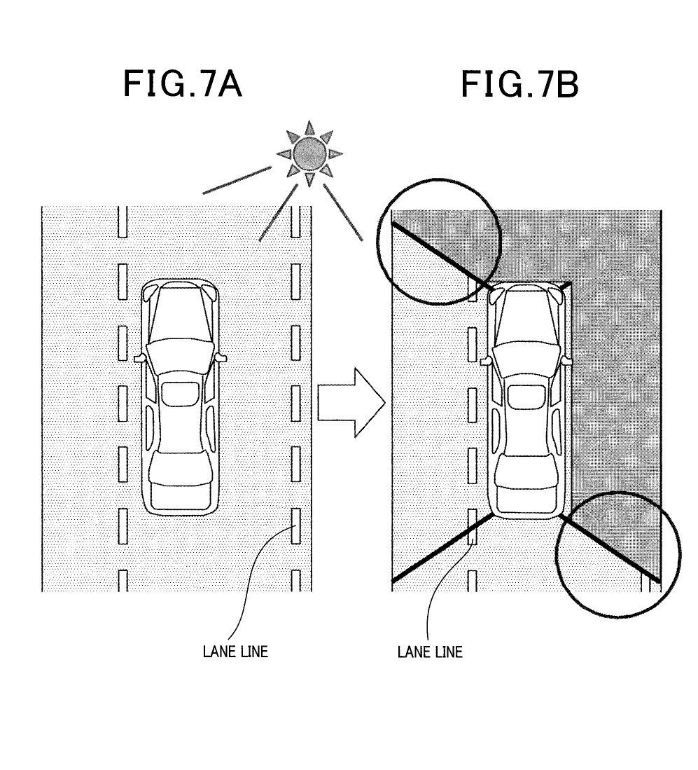

FIG. 7A and FIG. 7B are views showing one example of synthesized image data obtained by a conventional synthesized image generation device. In general, the conventional synthesized image generation devices synthesize four acquired images transmitted from four in-vehicle cameras such as a front view camera, a rear view camera, a right view camera and a left view camera. When sun light is irradiated at an upper right side toward the own vehicle shown in FIG. 7A, blocked up shadows are generated approximately in a half of the synthesized image data shown in FIG. 7B.

In particular, it is difficult for the conventional image processing section to correctly recognize the presence of a lane line designated by the circles shown in FIG. 7B. On the other hand, the image processing section 10 according to the exemplary embodiment can clearly and correctly recognize the presence of the lane lines shown in FIG. 6B and the lane line shown in FIG. 6C.

The operation flow goes to step S135 shown in FIG. 3. In step S135, the image processing section 10 performs the Hough transform process, which is a widely known method, for the synthesized image data. The image processing section 10 stores the recognition result of the lane line and a degree of the recognition accuracy into the memory section 12. Such a recognition accuracy of the lane line is determined on the basis of the number of edges, a regularity of the edges, a difference in road width between a detected road width and a predetermined road width, etc.

The operation flow goes to step S140. In step S140, the image processing section 10 compares the variable n with the number N of the combinations of acquired images.

In the exemplary embodiment, the number N of the combinations of the acquired images becomes 2 because there are two combinations of acquired images, one is a combination of the acquired images transmitted from the front view camera 21 and the rear view camera 22, and the other is a combination of the acquired images transmitted from the right view camera 23 and the left view camera 24.

When the detection result in step S140 indicates negation (“NO” in step S140), i.e. indicates that the value n is less than the number N of the combinations of the acquired images, the operation flow goes to step S145.

In step S145, the image processing section 10 increments the variable n by 1 ((n+1)→n). The operation flow returns to step S120.

On the other hand, when the detection result in step S140 indicates affirmation (“YES” in step S140), i.e. indicates that the value n is not less than the number N of the combinations of the acquired images, the operation flow goes to step S150.

In step S150, the image processing section 10 performs a recognition result synthesizing process.

In the recognition result synthesizing process, the image processing section 10 selects the lane line having a maximum recognition accuracy present at both the sides of the own vehicle in the recognition results in step S135.

The image processing section 10 generates a detection signal which corresponds to a magnitude of the recognition accuracy.

The operation flow goes to step S155. In step S155, the image processing section 10 performs a display process, i.e. generates a display instruction signal on the basis of the detection signal obtained in step S150. The image processing section 10 transmits the display instruction signal to the display unit 26 and the indicator 27 in order to display information corresponding to the magnitude of the recognition accuracy obtained in step S150.

The image processing section 10 completes the execution of the process in the flow chart shown in FIG. 3.

### Effects of the Synthesized Image Generation Device According to the Exemplary Embodiment

In the image display system 1 having the structure previously described, the image processing section 10 receives the acquired images transmitted from the in-vehicle cameras 21 to 24, i.e. the front view camera 21, the rear view camera 22, the right view camera 23 and the left view camera 24.

Further, the image processing section 10 selects some of a plurality of the acquired images transmitted from the in-vehicle cameras 21 to 24 so that the selected images are not overlapped in its image acquiring region on the road around the own vehicle. The image processing section 10 synthesizes the selected images to make synthesized image data.

According to the image display system 1 having the structure previously described, it is possible for the image processing section 10 to make synthesized image data of the selected images which are not overlapped in an image acquiring region on the surface of the road on which the own vehicle drives. As a result, even if an unclear image and a clear image acquired by the in-vehicle cameras are combined, it is possible for the image processing section 10 to easily and correctly detect the presence of one or more lane lines on the road of the own vehicle. The image processing section 10 can generate synthesized image data suitable for correctly extracting the lane lines on the road.

In the image display system 1 according to the exemplary embodiment having the structure previously described, the image processing section 10 selects the acquired images so that the image acquiring regions of the acquired images are not overlapped to each other. The image processing section 10 generates synthesized image data corresponding to the selected acquired images.

According to the image display system 1 having the structure previously described, it is possible for the image processing section 10 to generate a plurality of synthesized image data in order to extract road markings such as lane lines on the surface of the road, for example, painted by road making paint. It is therefore possible for the image processing section 10 to increase the detection accuracy for correctly detecting road markings such as lane lines on the surface of the road.

In the image display system 1 having the structure previously described, the image processing section 10 selects acquired images in opposite image acquiring regions when observed from the own vehicle. This selection allows the image acquiring regions of the selected acquired images to not overlap with each other.

In the image display system 1 having the structure previously described, the image processing section 10 generates a bird's eye view as the synthesized image data observed from above the own vehicle. Because the image display system 1 can provide such a bird's eye view to the driver of the own vehicle, it is possible to avoid a process of eliminating distortion when a road making is extracted from the acquired image. This provides a process of easily and simply extracting road markings such as a lane line on the surface of a road from the acquired images.

In the image display system 1 having the structure previously described, the image processing section 10 extracts road markings such as lane lines from the synthesized image data. Because the synthesized image data are obtained on the basis of the acquired images obtained in opposite image acquiring regions which are not overlapped with each other, it is possible for the image processing section 10 to correctly extract road markings such as a lane line with high accuracy.

### (Other Modifications)

The concept of the present invention is not limited by the exemplary embodiment previously described.

The exemplary embodiment previously described, the image processing section 10 selects a combination of the acquired images transmitted from a pair of the front view camera 21 and the rear view camera 22, or a pair of the right view camera 23 and the left view camera 24. However, the concept of the present invention is not limited by the exemplary embodiment. It is possible for the image processing section 10 in the image display system 1 to select a combination of not less than two acquired images according to the detection result transmitted from the environment state detection section 28. That is, the image processing section 10 selects the acquired images transmitted from the enabled in-vehicle cameras 21 to 24 according to the environmental state of the own vehicle and the road obtained by the environment state detection section 28.

According to the image display system 1 having the structure previously described, because the image processing section 10 selects acquired images without containing any blacked-out shadows, it is possible to increase the detection accuracy to detect road markings such as lane lines on the surface of a road by road making paint.

The image processing section 10 according to the exemplary embodiment previously described selects acquired images, where the image acquiring regions of which are not overlapped. However, the concept of the present invention is not limited by this. It is possible for the image processing section 10 in the image display system 1 to select acquired images having actual detection areas, which are not overlapped with each other, to be actually used for detecting road markings such as lane lines in the acquired images.

The image processing section 10 in the image display system 1 according to the exemplary embodiment extracts one or more lane lines from the acquired images. However, the concept of the present invention is not limited by the exemplary embodiment. It is possible for the image processing section 10 in the image display system 1 to extract road markings other than the lane lines on the surface of a road from the synthesized image data. In this case, the image processing section 10 performs a pattern matching process, etc. in order to recognize the presence of the road markings other than the lane lines on the surface of the road.

In the image display system 1 having the structure previously described, the front view camera 21 is arranged inside of a front bumper of the own vehicle, the rear view camera 22 is arranged inside of a rear bumper of the own vehicle, the right view camera 23 is arranged at the right wing mirror of the own vehicle, and the left view camera 24 is arranged at the left wing mirror of the own vehicle. However, the concept of the present invention is not limited by the exemplary embodiment. It is possible for the image processing section 10 in the image display system 1 to use a plurality of the in-vehicle cameras more than or less than four and arrange the in-vehicle cameras at different positions. It is possible to adjust a direction of the lens, i.e. have an optional direction of the lens (i.e. the direction of a central axis of the lens to acquire an image) of each of the in-vehicle cameras 21 to 24.

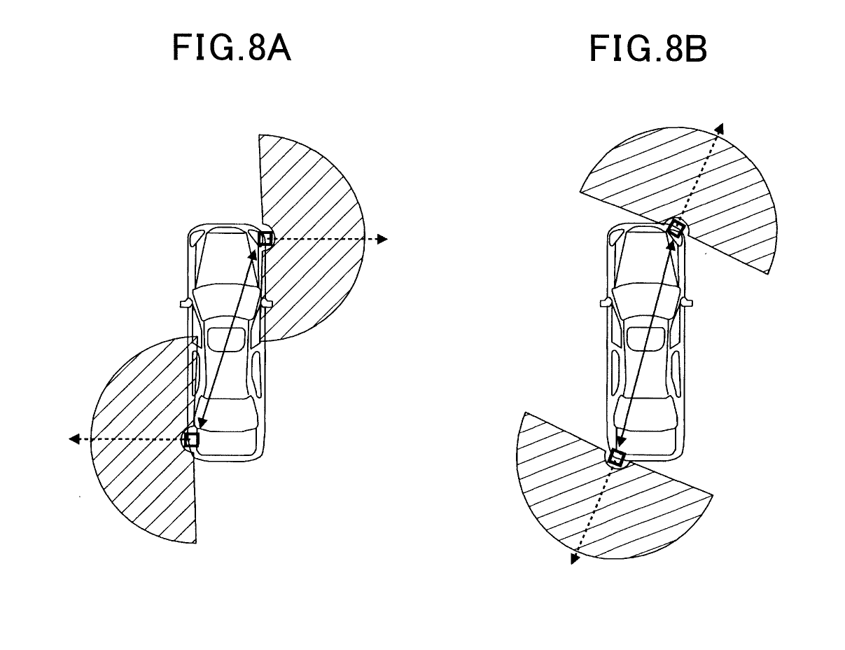

FIG. 8A and FIG. 8B are bird's eye views of a first example showing a combination of images acquired by the in-vehicle cameras to be processed by the image processing section 10 as the synthesized image generation device according to a first modification of the exemplary embodiment.

As shown in FIG. 8A, it is possible to arrange two in-vehicle cameras at a right front corner section and a left rear corner section of the own vehicle, and the image processing section 10 uses these in-vehicle cameras to obtain acquired images in an opposite image acquiring direction to each other, i.e. the directions of the central axis of the lenses of these in-vehicle cameras make an angle of 180 degrees.

The in-vehicle camera arranged at the right front corner section of the own vehicle has an image acquiring region toward a right front direction of the own vehicle which is at a right angle of the right side surface of the own vehicle as shown in FIG. 8A. Further, the in-vehicle camera arranged at the left rear corner section of the own vehicle has an image acquiring region toward a right rear direction of the own vehicle which is at a right angle of the left surface of the own vehicle as shown in FIG. 8A.

It is possible to further have a structure in which the in-vehicle camera arranged at the right front corner section of the own vehicle has an image acquiring region toward a right front direction of the own vehicle designated by the arrow shown in FIG. 8B. The in-vehicle camera arranged at the left rear corner section of the own vehicle has an image acquiring region toward a rear left direction of the own vehicle designated by the arrow shown in FIG. 8B. These image acquiring regions of the in-vehicle cameras are designated by the hatched areas shown in FIG. 8A and FIG. 8B.

In addition to the arrangement of the in-vehicle cameras in the image display system 1 shown in FIG. 8A and FIG. 8B, it is possible to arrange the in-vehicle cameras shown in FIG. 9A to FIG. 9C so that the image acquiring directions of these in-vehicle cameras make an angle of approximately 135 degrees, i.e. the directions of the central axis of the lenses of these in-vehicle cameras make an angle of approximately 135 degrees.

FIG. 9A to FIG. 9C are bird's eye views of a second example showing a combination of images acquired by the in-vehicle cameras to be processed by the image processing section 10 as the synthesized image generation device according to a second modification of the exemplary embodiment.

In more detail, as shown in FIG. 9A, it is possible to arrange two in-vehicle cameras at the right front side and the rear left side of the own vehicle so that these in-vehicle cameras acquire images in an opposite direction to each other. That is, the directions of the central axis of the lenses of these in-vehicle cameras make an angle of approximately 135 degrees. In order to suppress the overlapped image acquiring regions of the in-vehicle cameras, it is preferable to have the arrangement of the in-vehicle cameras shown in FIG. 8A and FIG. 8B which makes the angle of 180 degrees.

However, it is possible to arrange the two in-vehicle cameras so that the in-vehicle cameras are directed with their central axis apart by approximately 135 degrees so long as the image acquiring regions of which are not overlapped with each other.

As shown in FIG. 9A, it is possible to arrange the in-vehicle camera at a right front side of the own vehicle and the in-vehicle camera at left rear side of the own vehicle. The in-vehicle camera arranged at the right front side of the own vehicle has an image acquiring region toward a right front direction, designated by the arrow shown in FIG. 9A. The in-vehicle camera arranged at the left rear side of the own vehicle has an image acquiring region toward a left rear direction of the own vehicle designated by the arrow shown in FIG. 9A.

Further, as shown in FIG. 9B, it is possible to arrange the in-vehicle camera at a left front side of the own vehicle and the in-vehicle camera at right central side of the own vehicle. The in-vehicle camera arranged at the left front side of the own vehicle has an image acquiring region toward a front left direction, designated by the arrow shown in FIG. 9B. The in-vehicle camera arranged at the right central side of the own vehicle has an image acquiring region toward a right direction which is at a right angle of the right surface of the own vehicle designated by the arrow shown in FIG. 9B.

Still further, as shown in FIG. 9C, it is possible to arrange the in-vehicle camera at a central front side of the own vehicle and the in-vehicle camera at a right rear side of the own vehicle. The in-vehicle camera arranged at the center front side of the own vehicle has an image acquiring region toward a front direction, designated by the arrow shown in FIG. 9C, which is at a right angle of a front surface of the own vehicle. The in-vehicle camera arranged at the right rear side of the own vehicle has an image acquiring region toward a right rear direction designated by the arrow shown in FIG. 9C.

In each of the arrangements of the in-vehicle cameras shown in FIG. 9A to FIG. 9C, the directions of the central axis of the lenses of these in-vehicle cameras make an angle of approximately 135 degrees. These image acquiring regions of the in-vehicle cameras are designated by the hatched areas shown in FIG. 9A to FIG. 9C.

The first modification shown in FIG. 8A and FIG. 8B and the second modification shown in FIG. 9A to FIG. 9C have the same effects of the exemplary embodiment previously described.

The image processing section 10 according to the exemplary embodiment is equivalent to the synthesized image generation device used in the claims. The in-vehicle cameras 21 to 24 are equivalent to the image acquiring section used in the claims. The process in step S110 performed by the image processing section 10 is equivalent to the image acquiring section used in the claims. The process in step S120 performed by the image processing section 10 is equivalent to the acquired image selection section used in the claims.

The processes in step S125 and step S130 performed by the image processing section 10 are equivalent to the synthesized image generation section used in the claims. The processes in step S135 and step S150 performed by the image processing section 10 are equivalent to the road marking extracting section used in the claims.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A synthesized image generation device to be mounted on a motor vehicle, comprising:
an image acquiring section configured to acquire images transmitted from a plurality of in-vehicle cameras;
an acquired image selection section configured to select the acquired images transmitted from the in-vehicle cameras so that image acquiring regions of the in-vehicle cameras are not overlapped with each other, the selected acquired images being used for extracting road markings on a surface of a road; and
a synthesized image generation section configured to combine the selected acquired images and generate synthesized image data.

2. The synthesized image generation device according to claim 1, wherein the acquired image selection section selects a plurality of combinations of the acquired images transmitted from the in-vehicle cameras whose image acquiring regions are not overlapped with each other, and
the synthesized image generation section generates synthesized image data of each of the selected combinations of the acquired images.

3. The synthesized image generation device according to claim 1, wherein the acquired image selection section selects the number of acquired images as a combination of the acquired images according to an environment state of a road on which a motor vehicle drives.

4. The synthesized image generation device according to claim 2, wherein the acquired image selection section selects the number of acquired images as a combination of the acquired images according to an environment state of a road on which a motor vehicle drives.

5. The synthesized image generation device according to claim 1, wherein the acquired image selection section selects the acquired images transmitted from the in-vehicle cameras whose image acquiring regions are opposite to each other when observed from the motor vehicle.

6. The synthesized image generation device according to claim 2, wherein the acquired image selection section selects the acquired images transmitted from the in-vehicle cameras whose image acquiring regions are opposite to each other when observed from the motor vehicle.

7. The synthesized image generation device according to claim 1, wherein the synthesized image generation section generates a bird's eye view observed from above the motor vehicle on the basis of the acquired images selected by the acquired image selection section.

8. The synthesized image generation device according to claim 2, wherein the synthesized image generation section generates a bird's eye view observed from above the motor vehicle on the basis of the acquired images selected by the acquired image selection section.

9. The synthesized image generation device according to claim 1, further comprising a road marking extracting section configured to extract road markings from the acquired images selected by the acquired image selection section, and the road markings are on a surface of a road on which the motor vehicle drives by a road making paint.

10. The synthesized image generation device according to claim 2, further comprising a road marking extracting section configured to extract road markings from the acquired images selected by the acquired image selection section, and the road markings are on a surface of a road on which the motor vehicle drives by a road making paint.
